(19) United States
(12) Patent Application Publication
(10) Pub. No.: US 2026/0155597 A1
(43) Pub. Date: Jun. 4, 2026

(54) ELECTRICAL CONNECTOR HAVING VISUAL INDICATOR AND TACTILE INDICATOR INDICATING PROPER INDEPENDENT SECONDARY LOCK POSITIONING

(71) Applicant: Molex, LLC, Lisle, IL (US)

(72) Inventors: Dibakar Deb, Bangalore (IN); James M. Condon, Lemont, IL (US)

(21) Appl. No.: 19/123,083

(22) PCT Filed: Nov. 15, 2023
(86) PCT No.: PCT/IB2023/061569

§ 371 Date: Apr. 22, 2025

(30) Foreign Application Priority Data
Nov. 16, 2022 (IN) 202241065565

(51) Int. Cl. H01R 13/436; H01R 13/627

(52) U.S. Cl. CPC H01R 13/4365; H01R 13/506; H01R 13/5202; H01R 13/641

(57) ABSTRACT

An electrical connector has an independent secondary lock (ISL) and a male blade stabilizer within an outer housing. The ISL is movable relative to the outer housing and the male blade stabilizer from a pre-lock position to a locked position, and the male blade stabilizer is movable relative to the outer housing and the independent secondary lock from a pre-lock position to a locked position. An opening through the male blade stabilizer allows a user to visually determine if the ISL is properly seated. In addition, the ISL and the male blade stabilizer include features which prevent the movement of the male blade stabilizer into the locked position if the ISL is not properly seated, thereby providing a tactile feel and a visual indication during connector mating.

### RELATED APPLICATIONS

This application claims priority to India Application No. 202241065565 filed Nov. 16, 2022, which is incorporated herein by reference.

### FIELD OF THE DISCLOSURE

This disclosure relates to the field of electrical connectors having independent secondary locks.

### DESCRIPTION OF RELATED ART

In some applications, an independent secondary lock is used to increase the terminal retention force to hold terminals within an electrical connector housing of an electrical connector. The independent secondary lock must be properly seated within the electrical connector to avoid damage to the terminals during coupling of the electrical connector with another connector.

### BRIEF DESCRIPTION OF THE DRAWINGS

The present disclosure is illustrated by way of example, and not limited, in the accompanying figures in which like reference numerals indicate similar elements and in which:

FIG. 1 depicts a rear perspective view of an electrical connector system having a male electrical connector and a female electrical connector;

FIG. 2 depicts a rear exploded perspective view of the electrical connector system;

FIG. 3 depicts a front plan view of an outer housing of the male electrical connector;

FIG. 4 depicts a cross-sectional view of the outer housing;

FIG. 5 depicts a front perspective view of an independent secondary lock of the male electrical connector;

FIG. 6 depicts a front plan view of the independent secondary lock;

FIG. 7 depicts a front perspective view of a terminal housing of the male electrical connector;

FIG. 8 depicts a front plan view of the terminal housing;

FIG. 9 depicts a front perspective view of a male blade stabilizer of the male electrical connector;

FIG. 10 depicts a front plan view of the terminal housing;

FIG. 11 depicts a front plan view of the male electrical connector with the independent secondary lock in a pre-lock position;

FIG. 12 depicts a rear plan view of the male electrical connector with the independent secondary lock in the pre-lock position;

FIG. 13 depicts a front plan view of the male electrical connector with the independent secondary lock in a final locked position;

FIG. 14 depicts a rear plan view of the male electrical connector with the independent secondary lock in the final locked position;

FIG. 15 depicts a cross-sectional view of the male electrical connector with the male blade stabilizer in a pre-lock position;

FIG. 16 depicts cross-sectional views showing the process of movement of the independent secondary lock into the final locked position, and the mating of the male electrical connector and the female electrical connector; and

FIG. 17 depicts cross-sectional views showing the step which occur when the independent secondary lock is not properly moved into the final locked position, and the attempted mating of the male electrical connector and the female electrical connector.

### DETAILED DESCRIPTION

While the disclosure may be susceptible to embodiments in different forms, it is shown in the drawings and herein which is described in detail, specific embodiments with the understanding that the present disclosure is to be considered an exemplification of the principles of the disclosure and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

Directional terms such as front, rear, horizontal, vertical and the like are used for ease in explanation, and do not denote a required orientation in use.

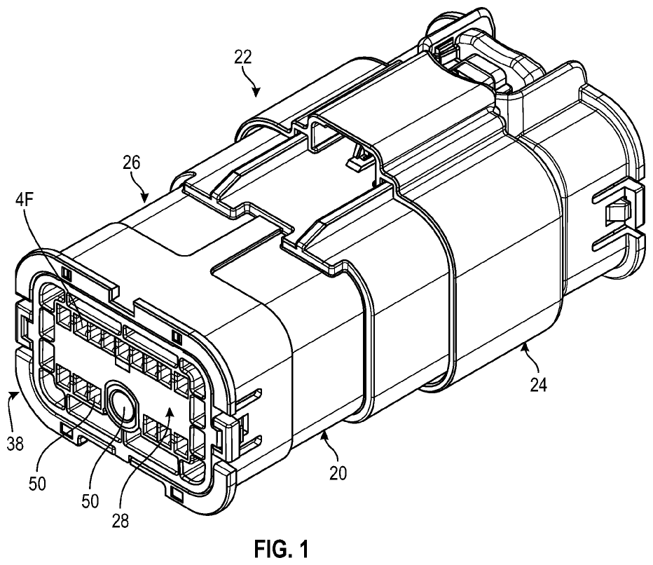

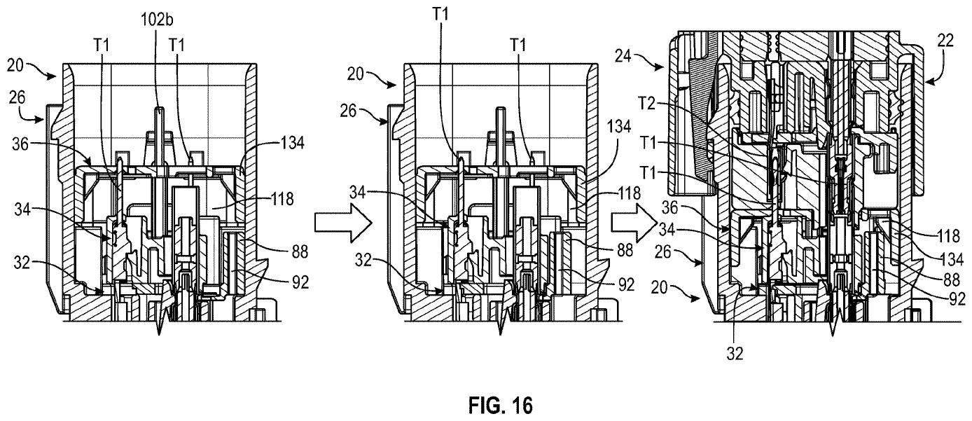

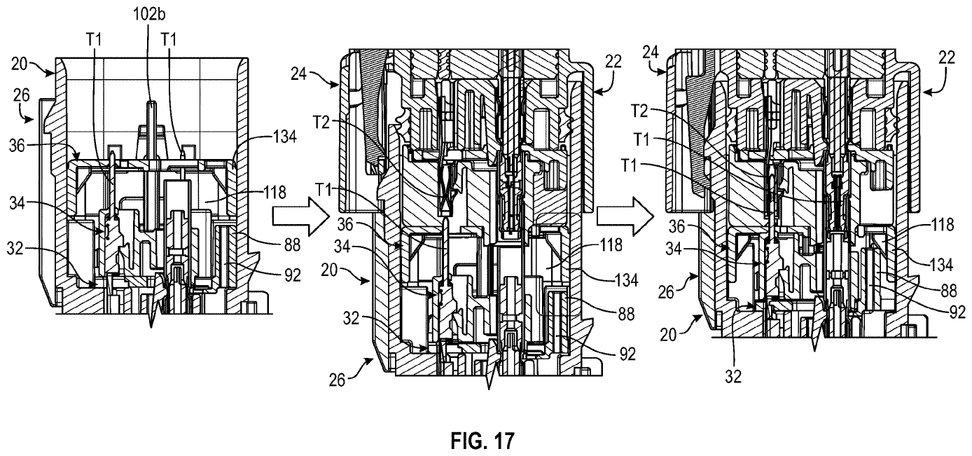

The present disclosure is directed to a male electrical connector 20 of an electrical connector system 22 which also includes a female electrical connector 24, see FIG. 1. A plurality of conductive terminals T1 are mounted within the male electrical connector 20 and a plurality of conductive terminals T2 are mounted within the female electrical connector 24, see FIGS. 16 and 17. When the male electrical connector 20 and the female electrical connector 24 are mated together, the terminals mate to form the electrical connector system 22.

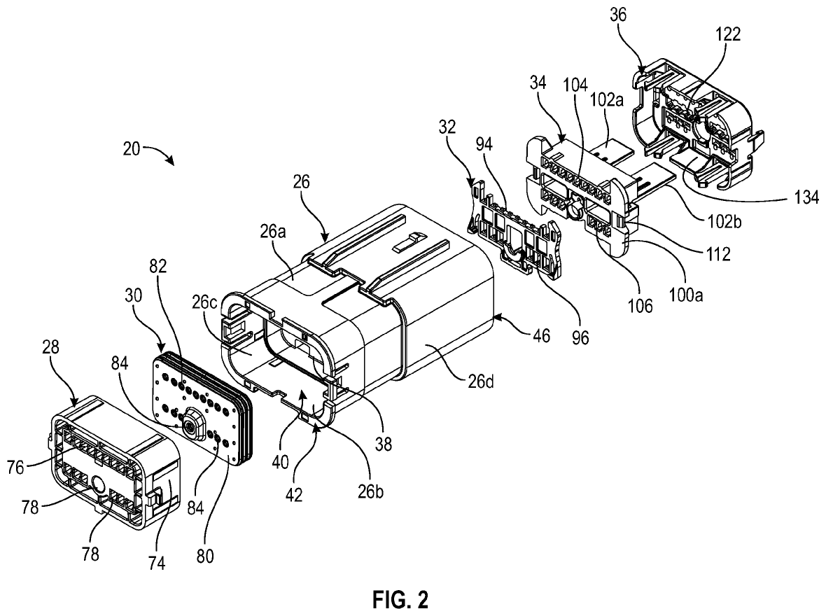

As shown in FIG. 2, the male electrical connector 20 includes an insulative outer housing 26 in which an insulative mat seal cap 28, a mat seal 30, an insulative independent secondary lock (ISL) 32, an insulative terminal housing 34, and an insulative male blade stabilizer 36 are positioned. The ISL 32 and the male blade stabilizer 36 serve to provide a visual indicator to a user that terminals mounted within the male electrical connector 20 are properly seated. The ISL 32 and the male blade stabilizer 36 also serve to prevent the final mating of the male electrical connector 20 with the female electrical connector 24 if the terminals are not properly seated. The outer housing 26, mat seal cap 28, terminal housing 34 are preferably formed of rigid materials such as Nylon (PA66). The ISL 32 and the male blade stabilizer 36 are preferably formed of rigid materials such as polybutylene terephthalate. The mat seal 30 is preferably formed of an elastomeric material.

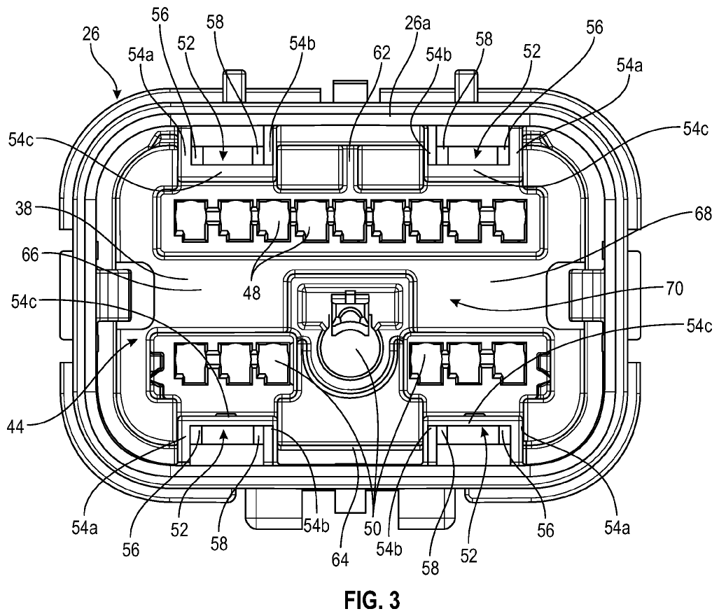

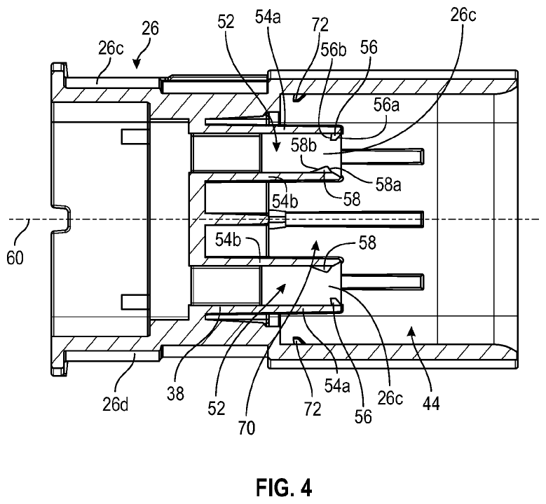

As shown in FIGS. 3 and 4, the outer housing 26 has top, bottom and side walls 26a, 26b, 26c, 26d and an internal central wall 38 which extends between the top, bottom and side walls 26a, 26b, 26c, 26d to define a longitudinally extending rear cavity 40 which extends from a rear end 42 of the outer housing 26 to the central wall 38, and to define a longitudinally extending front cavity 44 which extends from the central wall 38 to a front end 46 of the outer housing 26. Upper and lower rows of passageways 48, 50 extend through the central wall 38 from a rear end thereof to a front end thereof, which provide for communication between the rear and front cavities 40, 44.

A pair of upper generally U-shaped walls which form pockets 52 extend from the top wall 26a and the central wall 38 and into the front cavity 44, and a pair of lower generally U-shaped walls which form pockets 52 extend from the bottom wall 26b and the central wall 38 and into the front cavity 44. Each U-shaped wall includes first and second vertical walls 54a, 54b which extend from the respective top and bottoms walls 26a, 26b, and a horizontal wall 54c closing the ends of the vertical walls 54a, 54b. In each pocket 52, a first projection 56 extends into the pocket 52 from wall 54a and a second projection 58 extends into the pocket 52 from wall 54b. In each pocket 52, one projection, shown as projection 56, has a front surface 56a which is angled relative to a longitudinal axis 60 of the outer housing 26 and faces the front end 46 and a rear surface 56b which is perpendicular to the longitudinal axis 60 and faces the central wall 38, and the other projection, shown as projection 58, has a front surface 58a which is angled relative to the longitudinal axis 60 and faces the front end 46 and a rear surface 58b which is angled relative to the longitudinal axis 60 and relative to the front surface 58a and faces the central wall 38. The vertical walls 54b of the upper pockets 52 face each other and are spaced apart from each other to form a cavity portion 62 therebetween which forms part of the front cavity 44. The vertical walls 54b of the lower pockets 52 face each other and are spaced apart from each other to form a cavity portion 64 therebetween which forms part of the front cavity 44. The horizontal walls 54c of the upper pockets 52 are spaced from the horizontal walls 54c of the lower pockets 52 to form cavity portions 66, 68 therebetween which forms part of the front cavity 44. The cavity portions 66, 68 and the portion of the front cavity 44 therebetween form an area 70. A projection 72 extends from each side wall 26c, 26d into the respective cavity portion 64, 66 at a position spaced between the respective horizontal walls 54c. The projections 72 are between the upper and lower pockets 52.

The mat seal cap 28 is positioned at the rear end 42 of the outer housing 26 and within the rear cavity 40, and the mat seal 30 is positioned within the rear cavity 40 in front of the mat seal cap 28 and rear of the central wall 38. The ISL 32 is positioned within the cavity portions 64, 66, 68, and the terminal housing 34 is positioned partially within the cavity portions 64, 66, 68 and partially within the front cavity 44 of the outer housing 26, in front of the ISL 32, and rear of the male blade stabilizer 36. The male blade stabilizer 36 is within the front cavity 44 and positioned at the front end 46.

As shown in FIG. 2, the mat seal cap 28 includes a body 74 having upper and lower rows of spaced apart longitudinal passageways 76, 78 extending from a rear end thereof to a front end thereof. The mat seal 30 includes a body 80 having upper and lower rows of spaced apart longitudinal passageways 82, 84 extending from a rear end thereof to a front end thereof. Respective passageways 48, 76, 82 align with each other, and respective passageways 50, 78, 84 align with each other.

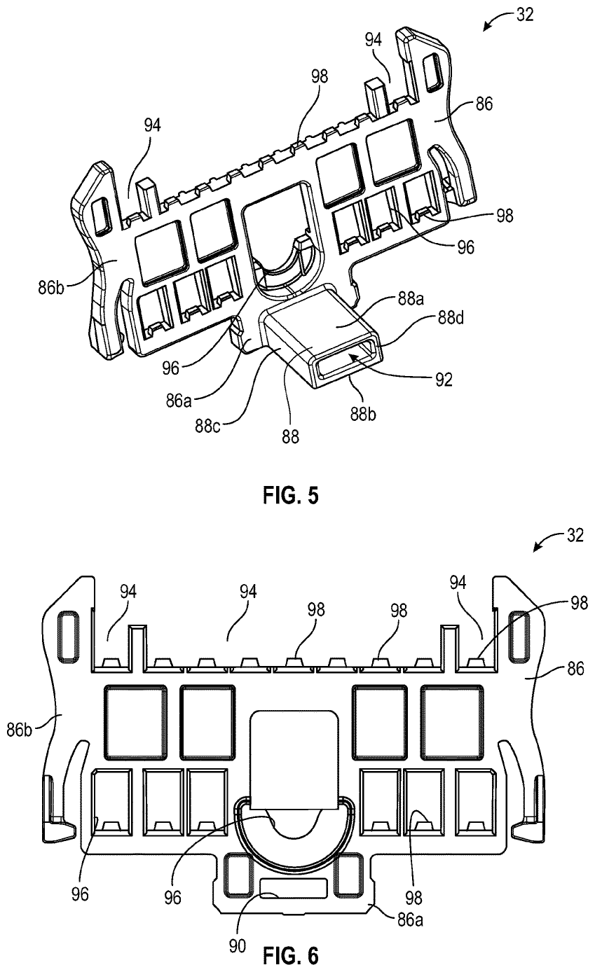

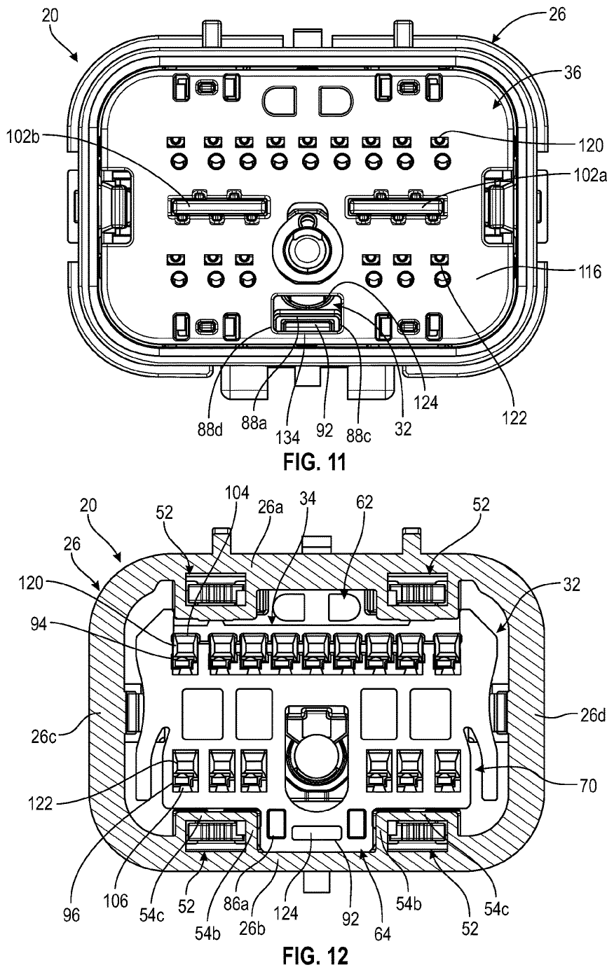

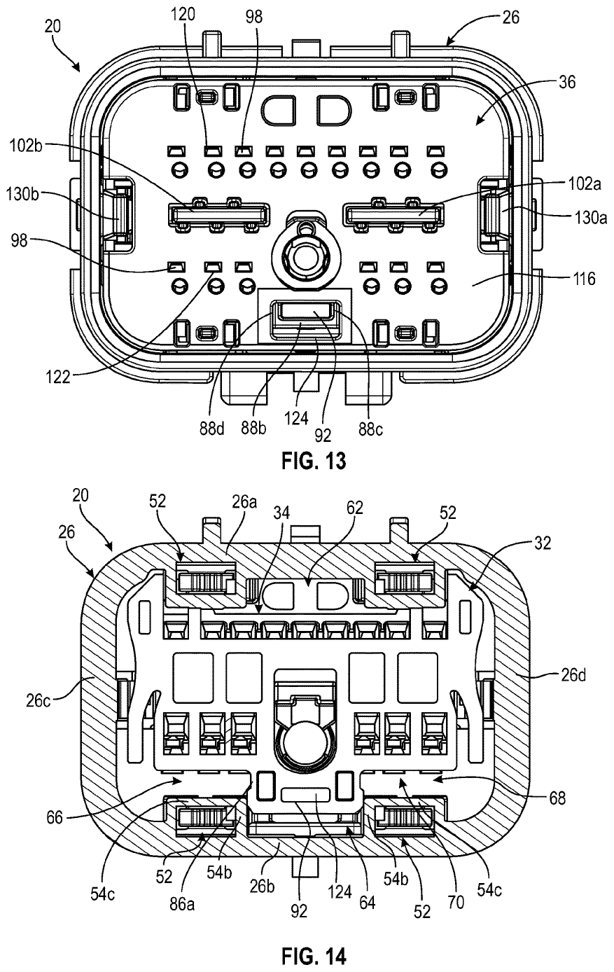

The ISL 32, see FIGS. 5 and 6, is assembled and shipped in pre-lock position, as shown in FIGS. 11 and 12, allowing insertion of the terminals into the male electrical connector 20. After insertion of the terminals into the male electrical connector 20, the ISL 32 is moved relative to the outer housing 26 and the terminal housing 34 to a final lock position, and as shown in FIGS. 13 and 14, using a servicing tool (not shown). The ISL 32 is movable in a direction which is perpendicular to a longitudinal axis of the outer housing 26. The ISL 32 includes a body 86 having a lower portion 86a which fits within the cavity portion 64 and an upper portion 86b which fits within the cavity portions 66, 68, and an extending portion 88 which extends from a front end of the lower portion 86a. The lower portion 86a includes an opening 90, see FIG. 6, extending from a rear end thereof to a front end thereof and which is elongated in a direction transverse to a longitudinal axis of the ISL 32. The extending portion 88 has top, bottom and side walls 88a, 88b, 88c, 88d which form a longitudinally extending opening 92 which aligns with the opening 90. The upper portion 86b includes upper and lower rows of spaced apart passageways 94, 96 extending from the rear end thereof to the front end thereof. Each passageway 94, 96 has at least one finger 98 extending upward from a bottom end thereof. The lower row of passageways 96 is above the opening 90.

The ISL 32 seats against the central wall 38. In the pre-lock position of the ISL 32, the lower portion 86a of the ISL 32 seats within the cavity portion 64 and the upper portion seats within the area 70. The ISL 32 can move upwardly and downwardly relative to the central wall 38 in a direction which is perpendicular to the longitudinal axis of the outer housing 26.

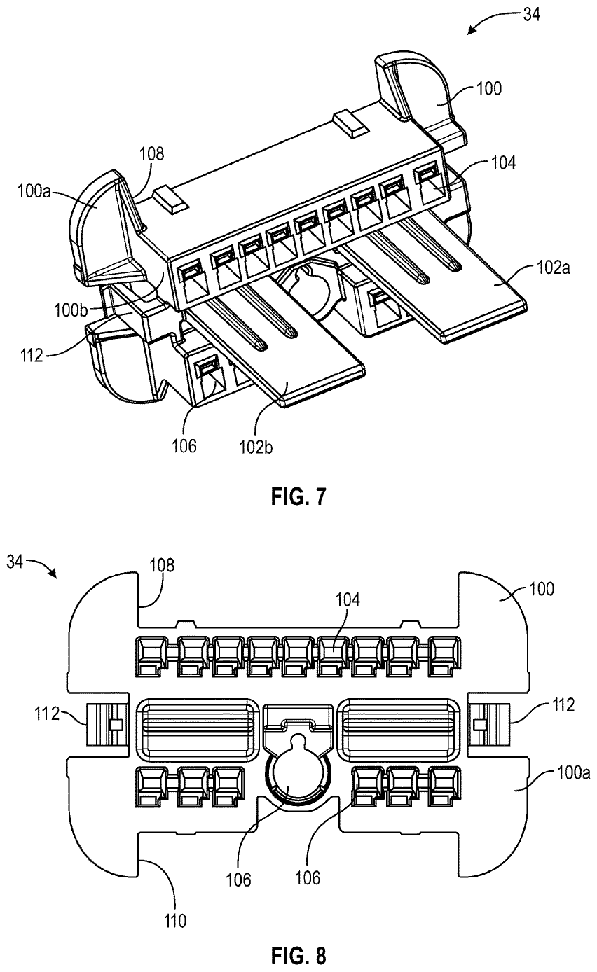

As shown in FIGS. 7 and 8, the terminal housing 34 includes a body 100 having a rear portion 100a, a front portion 100b and first and second spaced apart extending portions 102a, 102b extending from a front end of the front portion 100b. The outer perimeter of the rear portion 100a conforms in shape to the front cavity 44 of the outer housing 26. The front portion 100b has an outer perimeter which is smaller than the rear portion 100a. Upper and lower rows of spaced apart longitudinal passageways 104, 106 extend from a rear end of the rear portion 100a to a front end of the front portion 100b. An upper cutout 108 is provided in an upper end of the rear portion 100a above the upper row of passageways 104, and a lower cutout 110 is provided in a lower end of the rear portion 100a below the lower row of passageways 106. The extending portions 102a, 102b extend forward from the front portion 100b between the rows of passageways 104, 106. A flexible latch 112 having a barbed end extends from each opposite side of the front portion 100b and into cutouts in the sides of the rear portion 100a. Each barb on the respective flexible latch 112 is provided at the rear end of a flexible arm and faces outwardly.

The rear portion 100a of the terminal housing 34 seats against the front end of the ISL 32 and seats within the area 70. The barbs on the latches 112 engage with the projections 72 extending from the side walls 26c, 26d of the outer housing 26 to prevent easy removal of the terminal housing 34 from the outer housing 26. The extending portions 102a, 102b of the terminal housing 34 extend into the front cavity 44 of the outer housing 26. The extending portion 88 of the ISL 32 extends into the lower cutout 110 of the terminal housing 34. The lower cutout 110 has a vertical dimension which is greater than the vertical dimension of the extending portion 88 of the ISL 32.

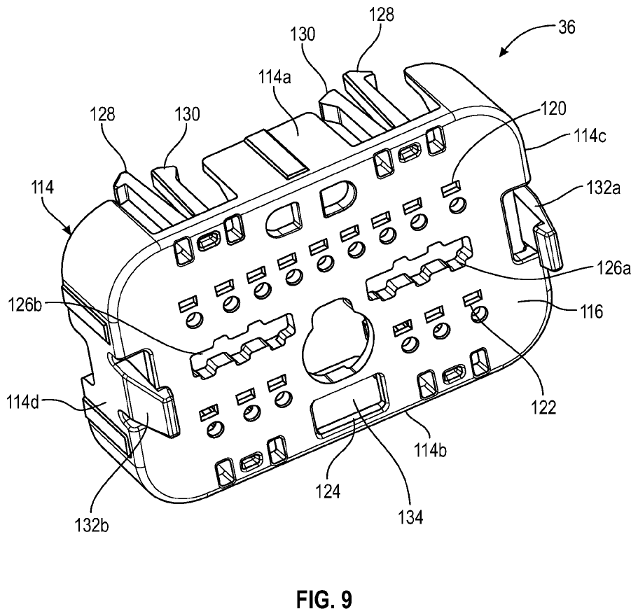

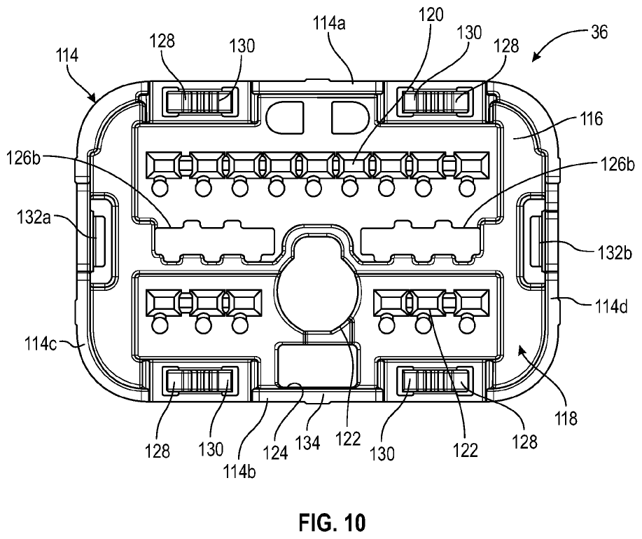

The male blade stabilizer 36, see FIGS. 9 and 10, is assembled and shipped in pre-lock position as shown in FIGS. 11 and 12. After movement of the ISL 32 to its final lock position, as shown in FIGS. 13 and 14, the male blade stabilizer 36 is moved to its final lock position by engagement with the female electrical connector 24. The male blade stabilizer 36 is movable in the longitudinal direction of the outer housing 26, and perpendicular to the direction of movement of the independent secondary lock 32. The male blade stabilizer 36 includes a body 114 having top, bottom and side walls 114a, 114b, 114c, 114d and a front wall 116 which extends between the walls 114a-d to define a recess 118. The walls 114a-d form an outer perimeter which generally corresponds to the shape of the front cavity 44 of the outer housing 26. Upper and lower rows of spaced apart longitudinal passageways 120, 122 extend from a rear end of the front wall 116 to a front end thereof. Respective passageways 104, 120 align with each other, and respective passageways 106, 122 align with each other. The front wall 116 has an opening 124 extending from the rear end thereof to the front end thereof and which is elongated in a direction transverse to a longitudinal axis of the male blade stabilizer 36. The lower row of passageways 122 is vertically spaced above the opening 124. The opening 124 has a dimension which is greater than the dimensions of the extending portion 88 of the ISL 32. The opening 124 is separate from the passageways 120, 122 and aligns with the lower cutout 110 of the terminal housing 34. A pair of openings 126a, 126b are provided through the front wall 116 between the rows of passageways 120, 122 and are dimensioned to receive the extending portions 102a, 102b of the terminal housing 34. The top and bottom walls 114a includes a pair of spaced apart cutouts, each cutout having a first flexible latch 128 and a second flexible latch 130 extending rearward from the front wall 116. Each latch 128, 130 includes a barb at the end of a flexible arm and the barbs of the latches 128, 130 in each cutout face away from each other. The barbs extend rearward of the rear end of the top and bottom walls 114a, 114b. The latches 128 are longer than latches 130. A pair flexible latches 132a, 132b extend forward from sides of the front wall 116. Each latch 132a, 132b includes a barb at the end of a flexible arm. A center portion 134 of the bottom wall 114b extends rearward from the front wall 116 and is between the pairs of latches 128, 130. The center portion 134 is below the opening 124.

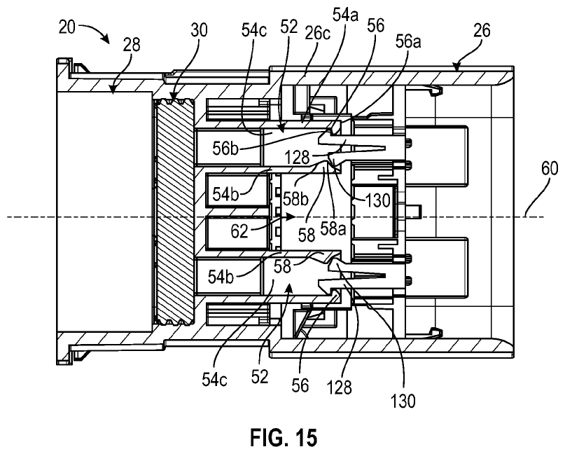

The front portion 100b of the terminal housing 34 sits partially within the recess 118 of the male blade stabilizer 36, the extending portions 102a, 102b of the terminal housing 34 extend through the elongated openings 126a, 126b of the male blade stabilizer 36, the latches 112 of the terminal housing 34 are engaged with the projections 72 on the outer housing 26, and the barbs on the latches 128 of the male blade stabilizer 36 are inserted into the pockets 52 and are passed by the projections 56 on the outer housing 26 as shown in FIG. 15. The barbs on the latches 130 of the male blade stabilizer 36 are partially within the pockets 52 but are not passed by the projections 58 on the outer housing 26 prior to mating with the female electrical connector 24, see FIG. 15. The male blade stabilizer 36 can move longitudinally relative to the terminal housing 34 and the outer housing 26.

In the pre-lock condition of the ISL 32 and when the male electrical connector 20 is not mated with the female electrical connector 24 (when the male electrical connector 20 is shipped for use), the ISL 32 is in the pre-lock position, and the male blade stabilizer 36 is in the pre-lock position as shown in FIGS. 11 and 12. When the ISL 32 is in the pre-lock position, a bottom end of the lower portion 86a of the ISL 32 abuts against the upper surface of the bottom wall 26b of the outer housing 26. The passageways 94 partially align with the passageways 104, 120, and the passageways 96 partially align with the passageways 106, 122. The extending portion 88 of the ISL 32 passes through the cutout 110 of the terminal housing 34. The opening 92 of the extending portion 88 of the ISL 32 partially aligns with the opening 124 in the male blade stabilizer 36. When a user views the male electrical connector 20 through the front end 46, the user will only see top wall 88a and part of the side walls 88c, 88d and part of the opening 92 of the extending portion 88 of the ISL 32; the user will not see the bottom wall 88b of the extending portion 88, see FIG. 11, since the bottom wall 88b is blocked by the central portion 134 of the male blade stabilizer 36. This visually indicates to the user that the ISL 32 of the male electrical connector 20 is in the pre-lock position.

Thereafter, terminals are inserted through the rear end 42 of the outer housing 26, through the rows of passageways 76, 78 in the mat seal cap 28, the rows of passageways 82, 84 in the mat seal 30 and the rows of passageways 48, 50 in the central wall 38. The terminals are then inserted through the rows of passageways 94, 96 in the ISL 32, through the rows of passageways 104, 106 in the terminal housing 34, and through the rows of passageways 120, 122 in the male blade stabilizer 36. After the terminals are inserted, the user inserts the servicing tool through the opening 124 in the male blade stabilizer 36 and into the portion of the opening 92 in the ISL 32 that is visible. Thereafter, the user manipulates the servicing tool to move the ISL 32 upward relative to the terminal housing 34 in a direction transverse to the terminal insertion direction until the fingers 98 on the ISL 32 engage with the terminals in a known manner to move the ISL 32 to the final lock position, see FIGS. 13 and 14. The extending portion 88 of the ISL 32 moves upward in the cutout 110 of the terminal housing 34. The lower portion 86a remains within the cavity portion 64 in the final lock position. The ISL 32 provides an additional securing function for the terminals independent of the primary locking mechanism. After removal of the servicing tool, the user can tell if the ISL 32 is properly engaged with the terminals by again viewing the male electrical connector 20 through the front end 46. If the user can see the bottom wall 88b of the extending portion 88 of the ISL 32 through the opening 124 of the male blade stabilizer 36 then the user knows that the ISL 32 is properly locked into the final lock position. Likewise, if the user cannot see the bottom wall 88b of the extending portion 88 of the ISL 32 through the opening 124 of the male blade stabilizer 36 then the user knows that the ISL 32 is not properly locked into the final lock position, and this indicates to the user that further action must be taken prior to mating with the female electrical connector 24.

After the ISL 32 is moved into the final lock position, the male electrical connector 20 is ready to be mated to the female electrical connector 24 as shown in FIG. 16. When the male electrical connector 20 is inserted into the female electrical connector 24, the front end of the female electrical connector 24 engages with the front end of the male blade stabilizer 36. As the male electrical connector 20 is further inserted into the female electrical connector 24, the male blade stabilizer 36 moves longitudinally relative to the outer housing 26 from its pre-lock position. The center portion 134 of the bottom wall 114b of the male blade stabilizer 36 passes under the bottom wall 88b of the extending portion 88 of the ISL 32. The latches 130 of the male blade stabilizer 36 flex and pass over the projections 58 on the outer housing 26, and the latches 128 move further into the pockets 52. In addition, the latches 132a, 132b on the male blade stabilizer 36 latch with projections (not shown) on the female electrical connector 24. The male blade stabilizer 36 stabilizes the terminals in the male electrical connector 20 during their connection with the terminals in the female electrical connector 24. The male blade stabilizer 36 also protects the blades of the terminal from being inadvertently knocked and bent, which can cause blade misalignment and hinder electrical continuity of the mated assembly.

In a situation wherein the ISL 32 is not properly moved into the final locked position, the extending portion 88 of the ISL 32 prevents the longitudinal movement of the male blade stabilizer 36 to its final locked position as shown in FIG. 17. In this situation, the front end of the female electrical connector 24 engages with the front end of the male blade stabilizer 36 and as the male electrical connector 20 is further inserted into the female electrical connector 24, the male blade stabilizer 36 moves longitudinally relative to the outer housing 26 until the center portion 134 of the male blade stabilizer 36 abuts against the bottom wall 88b of the extending portion 88 of the ISL 32. This prevents the further longitudinal movement of the male blade stabilizer 36 towards the rear end 42 and provides a tactile feel to the user during mating, as well as a visual indicator since the user will be able to see that the male electrical connector 20 is not fully inserted into the female electrical connector 24. This will cause the user to withdraw the male electrical connector 20 from the female electrical connector 24 and inspect the position of the ISL 32.

The use of the terms “a” and “an” and “the” and “at least one” and similar references in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An electrical connector comprising:
an outer housing;
an independent secondary lock mounted in the outer housing, the independent secondary lock having a plurality of terminal receiving passageways therethrough;
a terminal housing mounted in the outer housing, the terminal housing having a plurality of terminal receiving passageways therethrough; and
a male blade stabilizer mounted in the outer housing, the male blade stabilizer having a plurality of terminal receiving passageways therethrough, the male blade stabilizer having an opening therethrough which allows a user to visually see the independent secondary lock, the opening being separated from the terminal receiving passageways through the male blade stabilizer,
wherein the independent secondary lock is movable relative to the outer housing, the terminal housing and the male blade stabilizer from a pre-lock position to a locked position, wherein the terminal receiving passageways in the independent secondary lock are partially aligned with the terminal receiving passageways in the terminal housing and the male blade stabilizer when the independent secondary lock is in the pre-lock position and are capable of receiving terminals therein.

2. The electrical connector of claim 1, wherein the male blade stabilizer is movable relative to the outer housing, the independent secondary lock and the terminal housing from a pre-lock position to a locked position.

3. The electrical connector of claim 2, wherein the male blade stabilizer is movable in a longitudinal direction which is perpendicular to a direction of movement of the independent secondary lock.

4. The electrical connector of claim 2, wherein the independent secondary lock includes an extending portion which passes through the terminal housing.

5. The electrical connector of claim 4, wherein the male blade stabilizer includes a front wall having the opening therethrough, and a bottom wall extending from the front wall, wherein the bottom wall aligns with the extending portion when the independent secondary lock and the male blade stabilizer are in the pre-lock positions, and the bottom wall is configured to pass by the extending portion when the independent secondary lock and the male blade stabilizer are in the locked positions.

6. The electrical connector of claim 1, wherein each terminal receiving passageway in the independent secondary lock includes at least one finger which is configured to engage the terminal positioned therewithin.

7. The electrical connector of claim 1,
wherein the outer housing has a central wall dividing the outer housing into a front cavity and a rear cavity, the central wall having a plurality of terminal receiving passageways therethrough,
wherein the independent secondary lock, the terminal housing and the male blade stabilizer are mounted in the front cavity, and the independent secondary lock engages against the central wall, and
wherein the terminal receiving passageways in the central wall are partially aligned with the terminal receiving passageways in the independent secondary lock when the independent secondary lock is in the pre-lock position.

8. The electrical connector of claim 7, further comprising:
a mat cap seal mounted in the rear cavity of the outer housing, the mat cap seal having a having a plurality of terminal receiving passageways therethrough; and
a mat seal mounted in the rear cavity of the outer housing, the mat seal having a plurality of terminal receiving passageways therethrough.

9. The electrical connector of claim 1, wherein the terminal housing has a body through which the plurality of terminal receiving passageways are provided, and an extending portion extending from the body, wherein the extending portion of the terminal housing passes through an opening in the male blade stabilizer.

10. An electrical connector comprising:
an outer housing;
an independent secondary lock mounted in the outer housing, the independent secondary lock having a body and an extending portion extending forward from the body, the body having a plurality of terminal receiving passageways therethrough;
a terminal housing mounted in the outer housing, the terminal housing having a plurality of terminal receiving passageways therethrough, the extending portion passing through the terminal housing; and
a male blade stabilizer mounted in the outer housing, the male blade stabilizer having a plurality of terminal receiving passageways therethrough, wherein the male blade stabilizer is movable relative to the outer housing, the independent secondary lock and the terminal housing from a pre-lock position to a locked position, wherein the extending portion of the independent secondary lock engages with the body of the male blade stabilizer when terminals are not properly seated in the electrical connector and the male blade stabilizer is moved relative to the independent secondary lock.

11. The electrical connector of claim 10, wherein the male blade stabilizer has a body through which the plurality of terminal receiving passageways extend, and a bottom wall extending rearward from the body, wherein the extending portion of the independent secondary lock engages with the bottom wall of the male blade stabilizer when terminals are not properly seated in the electrical connector and the male blade stabilizer is moved relative to the independent secondary lock, wherein the bottom wall passes by the extending portion when the independent secondary lock and the male blade stabilizer are in the lock positions.

12. The electrical connector of claim 11, wherein the independent secondary lock is movable relative to the outer housing, the terminal housing and the male blade stabilizer from a pre-lock position to a locked position.

13. The electrical connector of claim 12, wherein the independent secondary lock is movable in a direction transverse to a longitudinal axis of the outer housing, and the male blade stabilizer is movable in a longitudinal direction which is parallel to the longitudinal axis of the outer housing.

14. The electrical connector of claim 11, wherein the male blade stabilizer includes a front wall having an opening therethrough which is separate from the terminal receiving passageways, and the extending portion of the independent secondary lock is visible through the opening.

15. The electrical connector of claim 11, wherein each terminal receiving passageway in the independent secondary lock includes at least one finger which is configured to engage the terminal positioned therewithin.

16. The electrical connector of claim 11,
wherein the outer housing has a central wall dividing the outer housing into a front cavity and a rear cavity, the central wall having a plurality of terminal receiving passageways therethrough,
wherein the independent secondary lock, the terminal housing and the male blade stabilizer are mounted in the front cavity, and the independent secondary lock engages against the central wall, and
wherein the terminal receiving passageways in the central wall are partially aligned with the terminal receiving passageways in the independent secondary lock when the independent secondary lock is in the pre-lock position.

17. The electrical connector of claim 16, further comprising:
a mat cap seal mounted in the rear cavity of the outer housing, the mat cap seal having a having a plurality of terminal receiving passageways therethrough; and
a mat seal mounted in the rear cavity of the outer housing, the mat seal having a plurality of terminal receiving passageways therethrough.

18. An electrical connector comprising:
an outer housing;
an independent secondary lock mounted in the outer housing, the independent secondary lock having a body having a plurality of terminal receiving passageways therethrough and an extending portion extending from the body;
a terminal housing mounted in the outer housing, the terminal housing having a plurality of terminal receiving passageways therethrough, the extending portion of the independent secondary lock passes through the terminal housing; and
a male blade stabilizer mounted in the outer housing, the male blade stabilizer having a front wall having a plurality of terminal receiving passageways therethrough and an opening therethrough which allows a user to visually see the independent secondary lock, the opening being separated from the terminal receiving passageways through the male blade stabilizer, the male blade stabilizer further including a bottom wall extending from the front wall,
wherein the independent secondary lock is movable relative to the outer housing, the terminal housing and the male blade stabilizer from a pre-lock position to a locked position, wherein the terminal receiving passageways in the independent secondary lock are partially aligned with the terminal receiving passageways in the terminal housing and the male blade stabilizer when the independent secondary lock is in the pre-lock position and are capable of receiving terminals therein,
wherein the male blade stabilizer is movable relative to the outer housing, the independent secondary lock and the terminal housing from a pre-lock position to a locked position, wherein the bottom wall aligns with the extending portion when the independent secondary lock and the male blade stabilizer are in the pre-lock positions, and the bottom wall is configured to pass by the extending portion when the independent secondary lock and the male blade stabilizer are in the locked positions, and wherein the extending portion of the independent secondary lock engages with the bottom wall of the male blade stabilizer when terminals are not properly seated in the electrical connector and the male blade stabilizer is moved relative to the independent secondary lock.

19. The electrical connector of claim 18, wherein each terminal receiving passageway in the independent secondary lock includes at least one finger which is configured to engage the terminal positioned therewithin.

20. The electrical connector of claim 19, further comprising:
a mat cap seal mounted in the outer housing, the mat cap seal having a having a plurality of terminal receiving passageways therethrough; and
a mat seal mounted in the outer housing, the mat seal having a plurality of terminal receiving passageways therethrough.
